(19) United States
(12) Patent Application Publication
(10) Pub. No.: US 2005/0227638 A1
(43) Pub. Date: Oct. 13, 2005

(54) Microwave band radio transmission device, microwave band radio reception device, and microwave band radio communication system

(75) Inventors: Eiji Suematsu, Nara (JP); John Kevin Twynam, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 10/505,958

(22) PCT Filed: Feb. 25, 2003
(86) PCT No.: PCT/JP03/02016

§ 371 Date: Aug. 27, 2004

(30) Foreign Application Priority Data
Feb. 28, 2002 (JP) 2002-054272

(51) Int. Cl. H04B 1/02; H04B 1/04; H01Q 11/12

(52) U.S. Cl. 455/118; 455/93

(57) ABSTRACT

An input modulation signal wave 108a is frequency-upconverted to an intermediate frequency signal wave by a frequency mixer 3. By adding a reference signal wave to the intermediate frequency signal wave frequency-upconverted by the frequency mixer 3 by means of a signal combiner 5a, an intermediate frequency multiplex signal wave 7 is generated. The intermediate frequency multiplex signal wave 7 is frequency-upconverted to a milliwave by a second frequency mixer 8. The multiplex signal wave in the milliwave band frequency-upconverted by the second frequency mixer 8 is amplified by a transmission amplifier 10 and transmitted as a radio multiplex signal wave 115 constituted of a radio reference signal wave 106 and a radio signal wave 107 from a transmission antenna 15. With this arrangement, there are provided a microwave band radio transmitter, a microwave band radio receiver and a microwave band radio communication system, which are excellent in controllability of a signal level of a transmission output and able to extend a radio transmission band and a radio transmission distance.

### TECHNICAL FIELD

The present invention relates to a microwave band radio transmitter, a microwave band radio receiver and a microwave band radio communication system.

### BACKGROUND ART

Conventionally, there has been a microwave band radio communication system described in JP 2001-53640 A. As shown in FIG. 12, this microwave band radio communication system includes a microwave band radio transmitter and a microwave band radio receiver. In this case, the microwave band herein refers to a frequency band that includes a milliwave band.

In the above-mentioned microwave band radio transmitter, an intermediate frequency signal wave 108a (frequency: fIF) modulated by an IF (Intermediate Frequency) modulation signal source 100 is generated, a local oscillation wave 106b (frequency: fLo) is generated by a milliwave band local oscillator 105, and the local oscillation wave 106b (frequency: fLo) is frequency-upconverted by a frequency converter 1001. The thus frequency-upconverted radio signal wave 107 (frequency: fRF) is extracted by a bandpass filter 102 of the milliwave band and the extracted radio signal wave 107 is multiplexed with the local oscillation wave 106b by a signal combiner 114. The local oscillation wave 106b (frequency: fLo) and the radio signal wave 107 are amplified to appropriate levels by a transmission amplifier 103 and radiated from a transmission antenna 15.

Then, the microwave band radio receiver on the reception side receives the radio signal wave 107 and the local oscillation wave 106b by a reception antenna 20, amplifies the waves to appropriate levels by a low-noise reception amplifier 111, extracts the radio signal wave 107 and the local oscillation wave 106b, which are the desired waves, by the bandpass filter 102 of the milliwave band and thereafter inputs the resulting waves to a frequency mixer 110. The radio signal wave 107 and the local oscillation wave 106b are subjected to square-law detection by the square-law detection characteristic possessed by the frequency mixer 110 to generate an intermediate frequency signal wave 108b, and the generated intermediate frequency signal wave 108b is inputted to a demodulator and tuner 113.

The aforementioned microwave band radio communication system has the following problems.

(1) It is difficult to control the output levels of the local oscillation wave (frequency fLO), the radio signal wave (frequency fRF) and the unnecessary one-side sideband signal wave on the transmission side.

(2) The radio transmission bandwidth is narrowed.

(3) Because of the square-law device used during the frequency downconversion on the reception side, the detection level in the frequency-downconverted intermediate frequency band (IF band) is small, and it is difficult to secure a sufficient transmission distance.

With regard to the aforementioned problem (1), the local oscillation wave 106b used for frequency-upconverting the intermediate frequency signal wave 108a to the radio signal wave 107 is directly added by the signal combiner 114, and a radio multiplex signal wave 115 that is the transmission wave of the radio signal wave 107 and the local oscillation wave 106b is generated. In this case, if the frequency fRF of the radio signal wave 107 and the frequency fIF of the intermediate frequency signal wave 108a are determined, then the relation of the local oscillation frequency fLO is uniquely determined. It is difficult to arbitrarily set the radio signal wave 107. (frequency: fRF) in the radio frequency band because of a problem concerning the Wireless Telegraphy Act, and the IF frequency band of the intermediate frequency signal wave 108a has already been a determined frequency with regard to, for example, the TV signal frequency and so on. Therefore, a frequency range of about 0.1 GHz to 2 GHz is normally used.

FIG. 13 shows the relation of the frequency spectrum in the microwave band radio communication system. As shown in FIG. 13, if the radio frequency fRF and the intermediate frequency fIF are fixed, then the local oscillation frequency fLO cannot be freely set because of the radio frequency fRF (=fLO+fIF or fLO−fIf) and the intermediate frequency fIF. Moreover, the local oscillation wave 106b (frequency: fLO) also becomes a transmission signal, and therefore, the local oscillation wave 106b (frequency: fLO) is also required to have a level accurately controlled concurrently with the radio signal wave 107 (frequency: fRF). Furthermore, when a sideband signal wave (e.g., upper sideband) of the radio multiplex signal wave 115 is normally used as the radio signal wave 107 (frequency: fRF), the lower sideband fLO-fIF component becomes an unnecessary signal wave, and this signal wave is required to be suppressed by the bandpass filter 102.

However, when the intermediate frequency signal wave 108a (frequency: fIF) has a frequency in the UHF band (e.g., fIF=0.5 GHz to 1.0 GHz), assuming that the frequency of the radio signal wave is in the milliwave band (e.g., fRF=59.5 GHz to 60.0 GHz), then the fLO+fIF component, the fLO component and the fLO-fIF component become 59.5 GHz to 60.0 GHz, 59 GHz and 58.0 GHz to 58.5 GHz, respectively, as shown in FIG. 13. Consequently, the intervals between the frequencies disadvantageously come close to one another, and it is difficult to suppress the fLO-fIF signal of the lower sideband signal that is the unnecessary signal wave by the normal milliwave-band bandpass filter (plane circuit filter and waveguide filter). Furthermore, the local oscillation wave 106b (frequency: fLO) also comes to have a frequency of 59 GHz, and it is required to directly accurately generate a high frequency.

Furthermore, with regard to the aforementioned problem (2), the frequency relation between the local oscillation wave 106b (frequency: fLO) and the radio signal wave 107 (frequency: fRF) is uniquely determined as described hereinbefore. For example, if the frequency fIF=0.5 GHz to 1.5 GHz and fRF=59.5 GHz to 60.5 GHz, then fLO disadvantageously becomes 59.0 GHz. Since the frequency interval between the local oscillation wave 106b (frequency: fLO) and the radio signal wave 107 (frequency: fRF) has a small range of 500 MHz to 1500 MHz, the second, third, . . . components of the intermediate frequency are disadvantageously outputted in the passband simultaneously with the frequency upconversion to the milliwave band due to the influence of the nonlinearity of the frequency upconverter 1001. In this case, the second harmonic wave becomes 60.0 GHz to 62.0 GHz and outputted in the passband, disadvantageously narrowing the radio transmission bandwidth.

Furthermore, with regard to the aforementioned problem (3), the square-law device is employed in the reception side frequency mixer 110 during the frequency downconversion on the reception side, and therefore, the detection level in the frequency-downconverted intermediate frequency band (IF band) is small. If the reception level from the reception antenna 20 is reduced by 6 dB, then the detection level of the intermediate frequency signal wave 108a after the frequency downconversion is reduced by 12 dB in terms of the relation between them. Therefore, the detection level in the intermediate frequency band (IF band) tends to fall into the noise band as the radio transmission distance is extended, and it is difficult to sufficiently secure the radio transmission distance.

### DISCLOSURE OF THE INVENTION

Accordingly, the object of this invention is to provide a microwave band radio transmitter, a microwave band radio receiver and a microwave band radio communication system capable of accurately controlling the levels of a radio signal wave to be transmitted, a local oscillation signal wave to be transmitted and an unnecessary suppression signal wave and increasing the radio transmission bandwidth and the transmission distance.

In order to achieve the aforementioned object, a microwave band radio transmitter of this invention comprises:
a multiplex wave generating means generating an intermediate frequency multiplex signal wave by adding a reference signal wave (e.g. a sine wave) whose level is controlled by a level control means to an input modulation signal wave or an intermediate frequency signal wave;
a second frequency converting means frequency-upconverting the intermediate frequency multiplex signal wave generated by the multiplex wave generating means to a microwave; and
transmission means amplifying a multiplex signal wave of a microwave band frequency-upconverted by the second frequency converting means and transmitting the amplified multiplex signal wave as a radio multiplex signal wave comprised of a radio reference signal wave and a radio signal wave.

According to the microwave band radio transmitter of the above-mentioned construction, the intermediate frequency multiplex signal wave is generated by adding the reference signal wave whose level is controlled by the level control means to the input modulation signal wave or the intermediate frequency signal wave by the multiplex wave generating means. In this case, the frequency-converted input modulation signal wave component, the local oscillation wave component and the reference signal wave component exist in the intermediate frequency multiplex signal wave. Subsequently, the intermediate frequency multiplex signal wave is frequency-upconverted by the second frequency converting means. Then, the frequency-upconverted multiplex signal wave is transmitted as a radio multiplex signal wave by the transmission means. This radio multiplex signal wave is constituted of the desired radio signal wave component and the desired radio reference signal wave component. The desired radio signal wave and radio reference signal wave can be thus separated from the unnecessary second local oscillation wave component and the unnecessary image signal wave component with regard to the frequency interval through the two-time frequency conversion, and the unnecessary component can be suppressed and filtered by the bandpass filter of the milliwave band. Moreover, the intermediate frequency signal wave and the reference signal wave inputted to the second frequency converting means can easily be subjected to level control frequency multiplex signal wave is generated by adding the reference signal wave to the input modulation signal wave or the intermediate frequency signal wave by the multiplex wave generating means. In this case, the frequency-converted input modulation signal wave component, the local oscillation wave component and the reference signal wave component exist in the intermediate frequency multiplex signal wave. Subsequently, the intermediate frequency multiplex signal wave is frequency-upconverted by the second frequency converting means. Then, the frequency-upconverted multiplex signal wave is transmitted as a radio multiplex signal wave by the transmission means. This radio multiplex signal wave is constituted of the desired radio signal wave component and the desired radio reference signal wave component. The desired radio signal wave and radio reference signal wave can be thus separated from the unnecessary second local oscillation wave component and the unnecessary image signal wave component with regard to the frequency interval through the two-time frequency conversion, and the unnecessary component can be suppressed and filtered by the bandpass filter of the milliwave band. Moreover, the intermediate frequency signal wave and the reference signal wave inputted to the second frequency converting means can easily be subjected to level control in the stage of the intermediate frequency of a low frequency by an AGC (Automatic Gain Control) amplifier or the like. This also makes it possible to easily control the output levels of the radio signal wave and the radio reference signal wave after the second frequency conversion. Therefore, the levels of the transmitted radio signal wave, the local oscillation signal wave and the unnecessary suppression signal wave can be accurately controlled, and the radio transmission bandwidth and the transmission distance can be extended. Moreover, when the transmission bandwidth of the intermediate frequency signal wave in the second frequency converting means is further extended, the transmission bandwidth can be extended in frequency by arranging a plurality of first frequency converting means.

Moreover, in one embodiment, the reference signal wave is a sine wave.

Moreover, a microwave band radio transmitter of one embodiment comprises a first frequency converting means frequency-upconverting the input modulation signal wave to an intermediate frequency signal wave.

Moreover, in one embodiment, the reference signal wave is a local oscillation wave used for the first frequency converting means.

According to the microwave band radio transmitter of the above-mentioned embodiment, by using the local oscillation wave used for the first frequency converting means for the reference signal wave, there is no need to employ separate oscillation sources, and the circuit construction can be simplified.

Moreover, a microwave band radio transmitter of one embodiment further comprises a local oscillator for supplying a local oscillation wave to the second frequency converting means, wherein
the local oscillator is comprised of a frequency multiplier whose input frequency is a frequency of the reference signal wave.

According to the microwave band radio transmitter of the above-mentioned embodiment, by employing the frequency multiplier as a local oscillator that supplies the local oscillation wave to the second frequency converting section, a reference signal wave of a stabilized frequency can be used, and stable operation can be achieved with a simple construction obviating the need for an independent oscillation source of a high frequency for the second frequency converting section.

Moreover, in one embodiment, the second frequency converting means is a harmonic mixer.

According to the microwave band radio transmitter of the above-mentioned embodiment, the local oscillation wave is not directly used as a transmission wave in the second frequency converting means, and therefore, a harmonic mixer can also be utilized. Therefore, the circuit construction and high frequency mounting are rendered remarkably easy, and this assures a lower-cost construction.

Moreover, by carrying out frequency conversion by the first frequency converting means, the interval between the frequency fLO2 of the local oscillation wave and the frequency fRF (=fLO1'fLO2+fIF1) of the radio signal wave becomes widened to fLO1+fIF1 (=fIF2). Therefore, with regard to the influence of the nonlinearity of the second frequency converting means on the second intermediate frequency signal wave (frequency: fIF2=fIf1+fLO1) that is the input signal to the second frequency converting means and the reference signal wave (frequency: fLO1), the frequency interval is widened in the milliwave band frequency-upconverted by the second frequency converting means, and the unnecessary signal wave component can easily be suppressed by the bandpass filter. As a result, the radio transmission bandwidth can be extended.

Moreover, in one embodiment, the second frequency converting means is an even harmonic mixer.

According to the microwave band radio transmitter of the above-mentioned embodiment, by employing the even harmonic mixer of an anti-parallel type diode pair and so on for the second frequency converting means, the second harmonic component can be suppressed and removed through the frequency-upconverting operation into the milliwave band. Consequently, the unnecessary signal wave component is not outputted, allowing an accurate transmission and the radio transmission bandwidth can be more extended.

Moreover, a microwave band radio transmitter of one embodiment comprises two systems of microwave band transmission means having the multiplex wave generating means, the second frequency converting means and the transmission means, wherein
a first input modulation signal is inputted to one of the microwave band transmission means,
a second input modulation signal is inputted to the other of the microwave band transmission means, and
a first radio multiplex signal wave and a second radio multiplex signal wave, both of which are generated by the respective microwave band transmission means, are transmitted in the forms of different polarized waves.

According to the microwave band radio transmitter of the above-mentioned embodiment, by transmitting the first radio multiplex signal wave in the form of a vertically polarized wave, transmitting the second radio multiplex signal wave in the form of a horizontally polarized wave and receiving the first radio multiplex signal wave and the second radio multiplex signal wave in the forms of the vertically polarized wave and the horizontally polarized wave, respectively, on the reception side, the transmission bandwidth can be extended.

Moreover, in one embodiment, the radio reference signal wave in the radio multiplex wave signal is transmitted at a power level higher than that of the radio signal wave.

According to the above-mentioned embodiment, by transmitting the radio reference signal wave in the radio multiplex signal wave at a level higher than that of the radio signal wave, the linear operation region of the frequency mixer on the reception side can be extended. That is, the radio signal wave is normally a multi-channel modulation signal wave, and the total power level of the radio signal wave of a bandwidth wider than that of the radio reference signal wave is large in comparison therewith. Therefore, by making the radio reference signal wave have a level higher than the total power of the radio signal wave and operating the frequency mixer on the reception side with a large signal by the radio reference signal wave, the linear detection operation region of the frequency mixer on the reception side can be extended.

Moreover, a microwave band radio receiver of this invention comprises a frequency converting means frequency-downconverting a radio multiplex signal wave transmitted from a transmission side by a radio reference signal wave contained in the radio multiplex signal wave.

According to the microwave band radio receiver of the above-mentioned embodiment, the intermediate frequency signal wave is generated by frequency-downconverting the radio multiplex signal wave transmitted from the transmission side by the radio reference signal wave contained in the radio multiplex wave signal. In this case, by controlling the gain at the time of amplifying the radio multiplex signal wave by the output signal level of the frequency-converted intermediate frequency signal wave, the transmission distance can be extended. That is, the linear detection operation is carried out in the region where the transmission distance is short and the reception level is very large, while the square-law detection operation is carried out in the region where the transmission distance is long and the reception level is small.

Moreover, a microwave band radio receiver of one embodiment comprises a variable gain amplifier for reception amplifying the radio multiplex signal wave, wherein
an intermediate frequency signal wave is generated by frequency-downconverting the radio multiplex signal wave amplified by the variable gain amplifier for reception by the frequency converting means, and a gain of the variable gain amplifier for reception is controlled by an output signal level of the intermediate frequency signal wave.

According to the microwave band radio receiver of the above-mentioned embodiment, by increasing the gain of the variable gain amplifier for reception when the reception level is small, the level inputted to the frequency mixer is increased, and the linear detection operation region is extended. When the reception level is too large, the gain of the variable gain amplifier for reception is reduced, and the input level to the frequency mixer is reduced. By doing so, a stable reception level can be obtained by reducing the nonlinear distortion caused in the large signal region of the frequency mixer and the amplifier, and the transmission distance can be extended.

Moreover, in a microwave band radio receiver of one embodiment, the frequency converting means is a frequency mixer that employs a microwave transistor.

According to the above-mentioned embodiment, by employing the frequency mixer that employs a microwave transistor for the frequency converting means and providing the frequency mixer by a two-terminal mixer that has two terminals of the input terminal and the output terminal, there is no need to provide a circuit for separating the radio frequency from the local oscillation frequency at the input port dissimilarly to the normal three-terminal type frequency mixer. In particular, the performance of the microwave transistor type frequency mixer, which has a low conversion loss, can be further improved.

Moreover, in a microwave band radio receiver of one embodiment, the frequency mixer is a frequency downconverter, which has an input terminal and an output terminal and has a short-circuit circuit to be short-circuited at a frequency of the radio multiplex signal wave or an intermediate frequency multiplex signal wave and connected to an output part of the microwave transistor to which the radio multiplex signal wave or the intermediate frequency multiplex signal wave is inputted.

According to the microwave band radio receiver of the above-mentioned construction, by providing the frequency mixer by the two-terminal mixer that has two terminals of the input terminal and the output terminal, there is no need to provide a circuit for separating the radio frequency from the local oscillation frequency at the input port dissimilarly to the normal three-terminal type frequency mixer. In particular, the performance of the microwave transistor type frequency mixer, which has a low conversion loss, can be further improved. Furthermore, by providing a short-circuit circuit (e.g., short-circuit stub), which is short-circuited at the radio multiplex wave signal frequency, at the output section of the microwave transistor to which the radio frequency multiplex wave is inputted and making the radio multiplex signal wave reflect to and fed back to the output terminal of the microwave transistor, the transistor operation shifts to larger signal operation, and the linear detection operation region is extended, allowing the radio transmission distance to be extended.

Moreover, in a microwave band radio receiver of one embodiment, the microwave transistor (HBT) of the frequency mixer is a heterojunction type bipolar transistor.

According to the above-mentioned embodiment, by employing a heterojunction type bipolar transistor for the microwave transistor of the frequency mixer, the linear operation region can be extended. This is because the internal operation of the transistor tends to easily enter the large signal operation region due to large mutual conductance possessed by the heterojunction type bipolar transistor in comparison with FET (Field Effect Transistor) or the like, and the linear detection operation region can be consequently extended.

Moreover, a microwave band radio receiver of one embodiment comprises two systems of microwave band radio receivers that have the frequency converting means, wherein
an intermediate frequency signal is generated by frequency-downconverting two radio multiplex signal waves transmitted in the forms of different polarized waves from a transmission side by the two microwave band receiving means, respectively.

According to the above-mentioned embodiment, by frequency-downconverting the two radio multiplex signal waves transmitted from the transmission side with mutually different polarized waves by the frequency converting means of the two systems, respectively, the frequency range of the transmission band can be extended, and a great amount of information can be transmitted.

Moreover, a microwave band radio receiver of this invention comprises a first frequency converting means frequency-downconverting a radio multiplex signal wave transmitted from a transmission side to an intermediate frequency multiplex signal wave by means of a local oscillator on a reception side; and
a second frequency converting means generating an intermediate frequency signal wave by frequency-downconverting by means of a reference signal wave contained in the intermediate frequency multiplex signal wave the intermediate frequency multiplex signal wave that has been frequency-downconverted by the first frequency converting means.

According to the microwave band radio receiver of the above-mentioned construction, the radio multiplex signal wave transmitted from the transmission side is frequency-downconverted to the first intermediate frequency multiplex signal wave by the first frequency converting means by using the local oscillator on the reception side. Then, the second intermediate frequency signal is generated (input signal on the transmission side is reproduced) by frequency-downconverting the intermediate frequency multiplex signal wave by the second frequency converting means by using the reference signal wave contained in the intermediate frequency multiplex signal wave frequency-downconverted by the first frequency converting means. By thus carrying out the linear detection operation through the first frequency conversion by using the independent local oscillator, the frequency conversion loss of the receiver can be reduced, and the radio transmission distance can be extended by the linear detection operation.

Moreover, in one embodiment, the second frequency converting means is a frequency mixer that has an input terminal and an output terminal and has a microwave transistor.

Moreover, the microwave band radio communication system of this invention comprises the microwave band radio transmitter and the microwave band radio receiver.

According to the microwave band radio communication system of the above-mentioned construction, the levels of the radio signal wave to be transmitted, the local oscillation signal wave and the unnecessary suppression signal wave can be accurately controlled, and the radio transmission bandwidth and the transmission distance can be extended.

Moreover, in one embodiment, the input modulation signal wave of the microwave band radio transmitter is a signal wave comprised of either one or a combination of two or more of a ground wave TV broadcasting wave signal, a satellite broadcasting intermediate frequency signal wave and a cable TV signal wave.

According to the microwave band radio communication system of the above-mentioned embodiment, with the radio transmission carried out by inputting to the microwave band radio transmitter a signal comprised of any one or a combination of two or more of the ground wave TV broadcasting signal wave, the satellite broadcasting intermediate-frequency signal wave and the cable TV signal wave as the input modulation signal wave, the ground wave TV broadcasting signal wave, the satellite broadcasting intermediate-frequency signal wave and the cable TV signal wave can be simultaneously transmitted while being multiplexed.

### BRIEF DESCRIPTION OF THE DRAWINGS

FIG. 1 is a block diagram showing the construction of a microwave band radio communication system of this invention;

FIG. 2 is a transmission spectrum of the microwave band radio transmitter of the above microwave band radio communication system;

FIG. 3 is a block diagram showing the construction of the microwave band radio transmitter in which two frequency converting sections are arranged in parallel with each other, and the microwave band radio receiver of this invention,;

FIG. 4 is a graph showing the detection characteristic of the frequency mixer of the above microwave band radio receiver;

FIG. 5 is a block diagram showing the construction of the microwave band radio communication system of the first embodiment of this invention;

FIG. 6 is a circuit diagram of an active mixer employed in the microwave band radio receiver of the above microwave band radio communication system;

FIG. 7 is a block diagram showing the construction of a microwave band radio communication system of the second embodiment of this invention;

FIG. 8 is a block diagram showing the construction of a microwave band radio communication system of the third embodiment of this invention;

FIG. 9 is a block diagram showing the construction of a microwave band radio communication system of the fourth embodiment of this invention;

FIG. 10 is a block diagram showing the other construction of the above microwave band radio communication system;

FIG. 11 is a block diagram showing the construction of a microwave band radio communication system of the fifth embodiment of this invention;

FIG. 12 is a block diagram showing the construction of a conventional microwave band radio communication system; and

FIG. 13 is a graph showing the relation of a frequency spectrum in the above microwave band radio communication system.

### BEST MODE FOR CARRYING OUT THE INVENTION

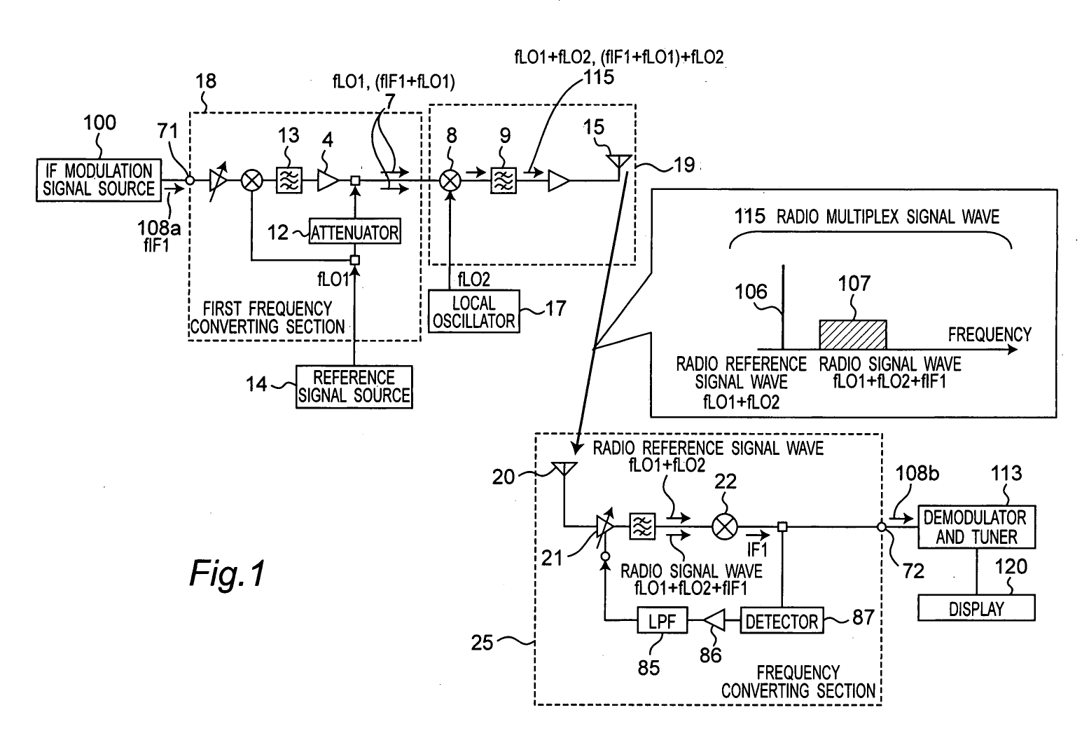

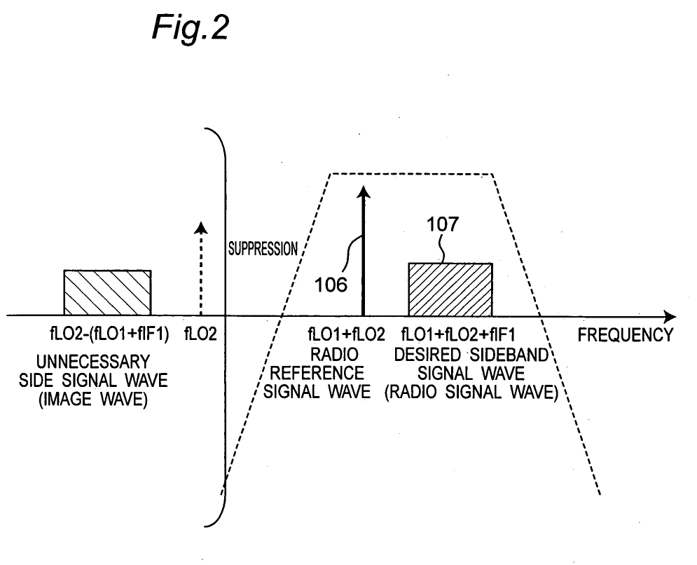

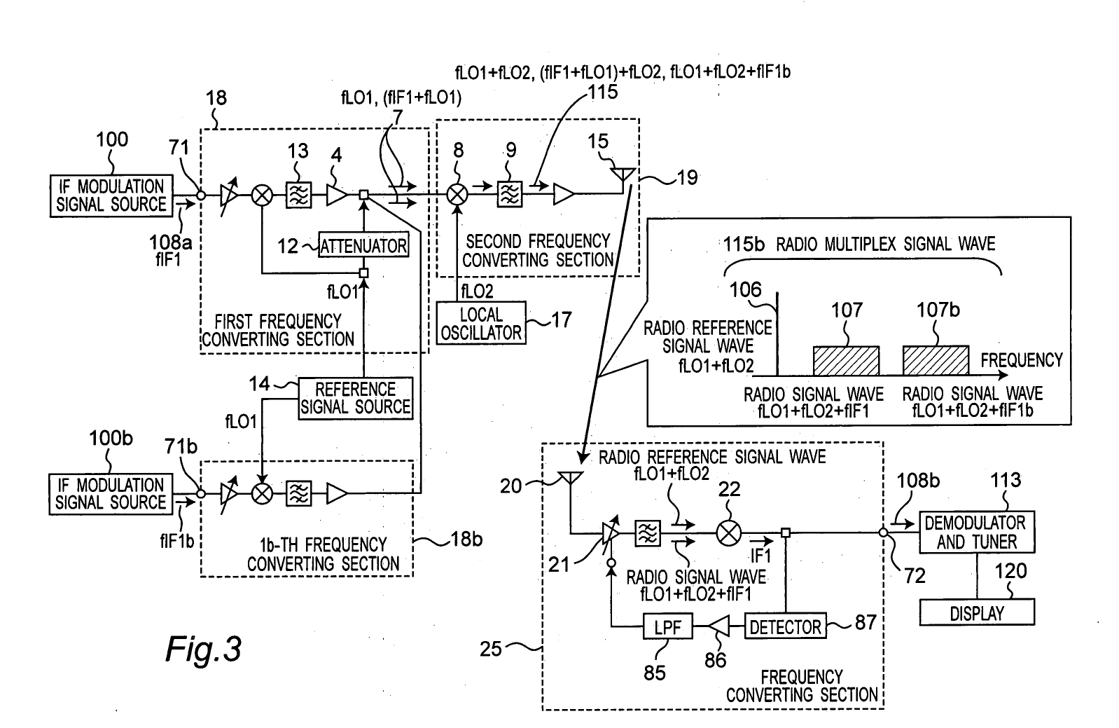

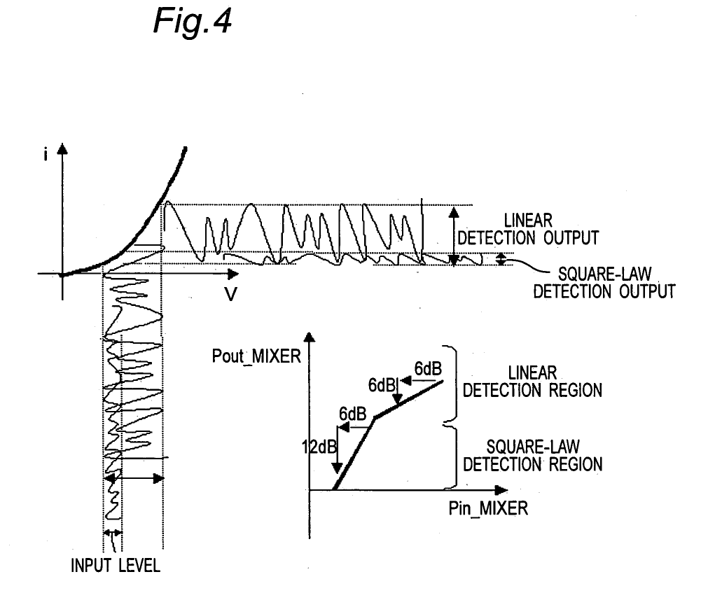

Before describing embodiments of this invention, the principle of the microwave band radio communication system of this invention will be first described below with reference to FIGS. 1 through 4. FIG. 1 is a block diagram showing the construction of the microwave band radio communication system, and FIG. 2 shows the transmission spectrum of the microwave band radio transmitter shown in FIG. 1. FIG. 3 is a block diagram showing the construction of a microwave band radio transmitter in which two frequency converting sections are arranged in parallel with each other, and a microwave band radio receiver, and FIG. 4 is a graph showing the detection characteristic of the frequency mixer of the microwave band radio receiver shown in FIG. 3. In this embodiment, a radio communication system that transmits and receives a radio signal wave in the milliwave band will be described. The band of the radio signal wave is not limited to the milliwave band, and this invention can be applied to the microwave frequency band including the milliwave band.

As shown in FIG. 1, an input modulation signal wave 108a is frequency-upconverted to an intermediate frequency signal wave in a first frequency converting section 18, and an intermediate frequency multiplex signal wave 7 is generated by adding a sine wave that contains a phase noise component and so on as a reference signal wave to the frequency-upconverted intermediate frequency signal. A radio multiplex signal wave 115 is generated by frequency-upconverting the intermediate frequency multiplex signal wave 7 to the milliwave band in a second frequency converting section 19, and the radio multiplex signal wave 115 is transmitted. In this case, by using the sine wave as the reference signal wave, the signal of the desired wave can be frequency-downconverted by using the sine wave on the reception side. This downconversion is described in detail in the present specification. In addition, the signal wave frequency-downconverted by the sine wave are dominated by the frequency stability and the phase noise characteristic of the sine wave itself, and therefore, it is possible to control the frequency stability and the phase noise characteristic by using the sine wave.

The above construction is able to solve the difficulties in controlling the output levels of the local oscillation wave 106 (frequency: fLo), the radio signal wave 107 (frequency: fRF) and the unnecessary one-side sideband signal wave on the transmission side. That is, an intermediate frequency multiplex signal wave 7 (frequency: fIFmp) is generated by carrying out frequency conversion to a second intermediate frequency (fIF1+fLO1) in the first frequency converting section 18 by using a reference signal source 14 (frequency: fLO1) that serves as a first local oscillation source and thereafter adding thereto a reference signal (frequency: fLO1) from the reference signal source 14. At this time, the frequency-converted fIF1+fLO1 component and the fLO1 component of the reference signal wave exist in the intermediate frequency multiplex signal wave 7 (frequency: fIFmp). Subsequently, frequency conversion is carried out in the second frequency converting section 19 by using a local oscillation source 17 (frequency: fLO2). The converted radio multiplex signal wave 115 (frequency: fRFmp) is constituted of the fIF1+fLO2+fLO1 component of the desired radio signal wave 107 (frequency: fRF) and the fLO2+fLO1 component of the desired radio reference signal wave 106 (frequency: fp).

FIG. 2 shows a frequency spectrum component after the first and second frequency conversions. In this invention, the radio signal wave 107 (frequency: fRF=fIF1+fLO2+fLO1) and the radio reference signal wave 106 (frequency: fp=fLO2+fLO1) of the desired waves can be separated from the fLO2 component of the second local oscillation signal wave of the unnecessary wave and the fLO2−(fLO1+fIF1) component of the unnecessary image signal wave with regard to the frequency interval through the two-time frequency conversions, and this enables suppression and filtering in a second bandpass filter 9.

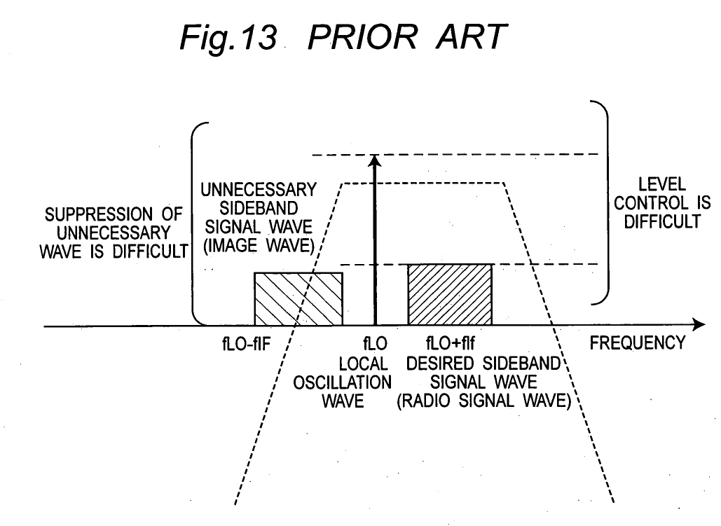

In concrete, assuming that the signal frequency fIF1 is 0.5 GHz to 1 GHz, the reference signal wave (frequency: fLO1) is 4 GHz and the local oscillation wave (frequency: fLO2) is 55 GHz, then the fLO1+fLO2 (=fp) component and the fLO2+fLO1+fIF (=fRF) component in the radio multiplex signal wave 115 (frequency: fRFmp) become 59 GHz and 59.5 GHz to 60 GHz, respectively, while the frequency fLO2 of the unnecessary wave component becomes 55 GHz and the frequency fLO2-(fLO1+fIF1) of the image signal wave becomes 54.0 GHz to 54.5 GHz. The frequency interval between the radio reference signal wave 106 (frequency: fp) of the desired wave and the local oscillation wave (frequency: fLO2) of the unnecessary wave is separated by 4 GHz, and this enables filtering in the second bandpass filter 9 that is the normal bandpass filter of the milliwave band. This is clarified by comparison with the conventional spectrum components (FIG. 13). For example, assuming that the frequency fIF is 0.5 GHz to 1 GHz and the frequency fLO=59.0 GHz, then the frequency fLO of the local oscillation wave 106b (radio signal wave) becomes 59.0 GHz, and the frequency fLO-fIF of the image signal wave of the unnecessary wave becomes 58.0 GHz to 58.5 GHz. The frequency interval between them is only 0.5 GHz, and it is evident that the separation and filtering in the second bandpass filter 9 are difficult.

In addition, in the above-mentioned construction, the second intermediate frequency signal wave (frequency: fIF2=fLO1+fIF1) and the reference signal wave (frequency: fLO1) inputted to the second frequency converting section 19 can easily be subjected to level control in the intermediate frequency stage of a low frequency by a variable attenuator 12 (AGC (Automatic Gain Control) amplifier or the like) (FIG. 1). This also makes it possible to control the output levels of the radio signal wave 107 (frequency: fRF=fLO1+fLO2+fIF) and the radio reference signal wave 106 (frequency: fp=fLO1+fLO2) after the second frequency conversion.

In addition, it becomes possible to use a harmonic mixer such as an even harmonic mixer for the second frequency converting section 19 since the local oscillation wave (frequency: fLO) is not directly used as a transmission wave. Although the local oscillation frequency fLO2 of this construction has been 55 GHz used in the aforementioned concrete example, an oscillation signal of 5 GHz/2=27.5 GHz and 55 GHz/4=13.75 GHz can also be used. Therefore, the circuit construction and the high frequency mounting can be achieved remarkably easily at lower cost.

Further, by carrying out frequency conversion in the first frequency converting section 18, the interval between the local oscillation frequency fLO2 and the frequency fRF (=fLO1+fLO2+fIF1) of the radio signal wave 107 becomes extended to fLO1+fIF1 (=fIF2). Therefore, the influence of the nonlinearity of the second frequency converting section 19 on the second intermediate frequency signal wave 7 (frequency: fIF2=fIf1+fLO1) of the input signal to the second frequency converting section 19 and on the reference signal wave (frequency: fLO1), i.e., the influence of the second, third, fourth, fifth, . . . components of the frequencies of the local oscillation frequencies fLO1 and fIF2 can be ignored. The reason for the above is that the frequency interval becomes widened in the milliwave band obtained through the frequency upconversion in the second frequency converting section 19, and filtering can easily be achieved by the bandpass filter 9.

For example, assuming that the frequencies fLO1=4.0 GHz, fIF2=4.5 GHz to 5.5 GHz and fLO2=55.0 GHz, then the frequency fp of the radio reference signal wave becomes 59.0 GHz and the frequency fRF of the radio signal wave becomes 59.5 GHz to 60.5 GHz through the frequency upconversion by the second frequency converting section 19. On the other hand, the second, third, . . . harmonic components of the reference signal wave (frequency: fLO1) and the second intermediate frequency signal wave (frequency: fIF2) respectively become as follows.
2*fLO1=8 GHz, 2*fIF2=9 GHz to 11 GHz,
3*fLO1=12 GHz, 3*fIF2=13.5 GHz to 16.5 GHz,

By being frequency-upconverted to the milliwave band, fLO=55 GHz is added to these frequencies, so that frequency spectrum components are generated at the frequencies of 63 GHz, 64 GHz to 66 GHz, 67 GHz and 68.5 GHz to 71.5 GHz. However, since the frequency components are separated by at least 1.5 GHz or more apart from the radio signal wave (frequency: fRF), the frequency components can easily be suppressed by the bandpass filter 9, and the radio transmission bandwidth can be consequently extended.

Furthermore, by employing an even harmonic mixer of an anti-parallel type diode pair or the like for the second frequency mixer 8, the second harmonic wave components of fIF2 and fLO1 can be suppressed and removed by the operation of frequency upconversion to the milliwave band. Therefore, in the aforementioned example, the components of the frequencies of 63 GHz and 64 GHz to 66 GHz are not outputted, and the radio transmission bandwidth can be extended more accurately. When the transmission bandwidth of the intermediate frequency signal wave (frequency: fIF1) is further extended, it is also possible to extend the transmission frequency band by arranging a 1b-th frequency converting section 18b in parallel with the first frequency converting section 18 as shown in FIG. 3. It is acceptable to arrange two or more frequency converting sections in parallel with the first frequency converting section 18 without limitation to the case of two sections arranged in parallel.

On the other hand, by generating a first radio multiplex signal wave 115 and a second radio multiplex signal wave 115b and transmitting the respective signal waves in the forms of different polarized waves, the transmission bandwidths of the intermediate frequency signal wave that serves as a first input signal and the intermediate frequency signal wave that serves as a second input signal can be extended in the aforementioned milliwave band transmitter. In concrete, by transmitting the first radio multiplex signal wave 115 and the second radio multiplex signal wave 115b in the forms of a vertically polarized wave and a horizontally polarized wave, respectively, and receiving the first and second radio multiplex signal waves 115 and 115b in the forms of the vertically polarized wave and the horizontally polarized wave, respectively, on the reception side, the transmission bandwidth can be extended.

Moreover, in the milliwave band receiver, the radio multiplex signal wave 115 transmitted from the transmission side is frequency-downconverted by the radio reference signal wave 106 (frequency: fp) contained in the radio multiplex wave signal, generating the intermediate frequency signal wave 108a. In this case, the reception amplifier 21 serves as a variable gain amplifier and is able to control the gain of the reception amplifier 21 according to the output signal level of the frequency-converted intermediate frequency signal wave (frequency: fIF). With this arrangement, as indicated by the detection characteristic of the frequency mixer 22 on the reception side in FIG. 4, linear detection operation is achieved in the region where the transmission distance is short and the reception level is very large, while square-law detection operation can be achieved in the region where the transmission distance is long and the reception level is small.

That is, the low-noise reception amplifier 21 has an automatic gain control (AGC) function. When the reception level is small, the level of the input to the frequency mixer 22 is kept constant by increasing the gain of the reception amplifier 21, allowing the linear detection operation range to be extended. When the reception level is too large, the nonlinear distortion caused in the large signal region of the frequency mixer 22 and the amplifier is reduced by reducing the gain of the amplifier 21 and reducing the input level of the frequency mixer 22, so that a stabilized reception level can be obtained.

Furthermore, it is also possible to achieve improvement with the construction of a two-terminal type frequency mixer 22 that employs a microwave transistor in the milliwave radio receiver. The frequency mixer 22 is allowed to be a two-terminal mixer that has two terminals of an input terminal and an output terminal. Dissimilarly to a normal three-terminal type frequency mixer that has a local oscillation LO port, a radio frequency RF port and an intermediate frequency IF port, there is no need of a circuit that separates the RF port from the LO port at the input port, and in particular, the performance of the frequency mixer of the microwave transistor type that has a low conversion loss can be further improved. That is, by inputting the radio multiplex signal wave 115 to the input terminal and providing a short-circuit stub as one example of the short-circuit circuit that is short-circuited at the radio multiplex wave signal frequency in the output section of the microwave transistor, the internal operation of the transistor shifts to larger signal operation through the reflection and feedback of the radio multiplex signal wave 115 to the output terminal of the microwave transistor to widen the linear detection operation region in FIG. 4, and the radio transmission distance can be extended.

Furthermore, it is also possible to extend the linear operation region by employing a heterojunction type bipolar transistor (HBT) for the microwave transistor. This is because the internal operation of the transistor tends to easily enter the large signal operation region due to a large mutual conductance possessed by the HBT in comparison with FET and so on and the linear detection operation region can be consequently extended.

In addition, by transmitting the radio reference signal wave 106 (frequency: fp) in the radio multiplex signal wave 115 at a level at least 3 dB or more higher than that of the radio signal wave 107 (frequency: fRF) on the milliwave band transmitter side, the linear operation region of the frequency mixer 22 on the reception side can be extended. That is, the radio signal wave (frequency: fRF) is normally a multiple (multi-channel) modulation signal wave, and the total power level of the radio signal wave of a wide bandwidth is large in comparison with the radio reference signal wave 106 of the reference frequency fp. Therefore, by making the level of the radio reference signal wave (frequency: fp) sufficiently larger, i.e., at least 3 dB or more larger than the total power of the radio signal wave (frequency: fRF) to operate the frequency mixer 22 with a large signal by the radio reference signal wave (frequency: fp), the linear detection operation region can be extended.

The microwave band radio transmitter, the microwave band radio receiver and the microwave band radio communication system of this invention will be described in detail below on the basis of the embodiments shown in the drawings.

### First Embodiment

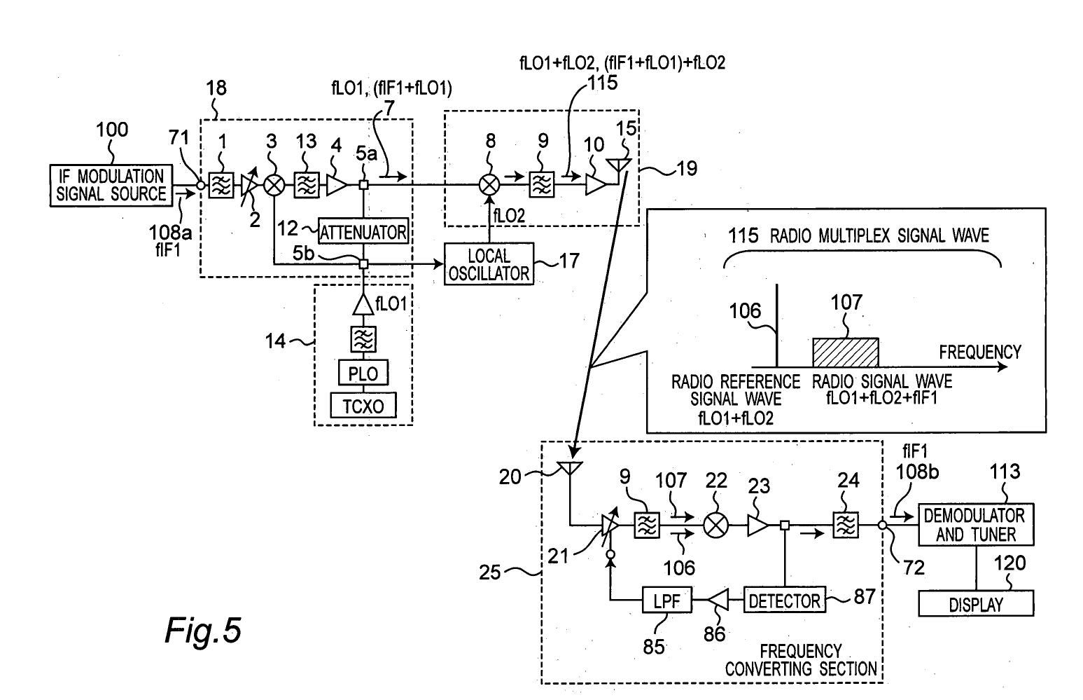

FIG. 5 is a block diagram showing the construction of the microwave band radio communication system of the first embodiment of this invention, and this microwave band radio communication system is constructed of a microwave band radio transmitter and a microwave band radio receiver. In FIG. 5, the components that operate and function similarly to those of FIGS. 1 through 4 are denoted by the same reference numerals.

As shown in FIG. 5, in the above-mentioned microwave band radio transmitter, an intermediate frequency signal wave 108a (frequency: fIF1) modulated by an IF modulation signal source 100 is generated and inputted to a first frequency converting section 18. Next, the signal wave is inputted to a frequency mixer 3 that serves as the first frequency converting means at an appropriate level via a bandpass filter 1 and a variable amplifier 2, and the intermediate frequency signal wave 108a is frequency-upconverted to a second intermediate frequency signal wave (frequency: fIF2) by the frequency mixer 3 by using a reference signal wave (frequency: fLO1) from the reference signal source 14. The frequency-upconverted second intermediate frequency signal wave (frequency: fIF2) has a signal of either the upper sideband or the lower sideband selected by a first bandpass filter 13 and has the unnecessary signal waves of the second, third and distortion component signals and so on of the first intermediate frequency signal wave 108a (frequency: fIF1) removed. In this first embodiment, the signal of the upper sideband is selected as the second intermediate frequency signal wave, and the relation of frequency fIF2=fLO1+fIF1 of the second intermediate frequency signal wave is possessed.

The second intermediate frequency signal wave (frequency: fIF2) is amplified to an appropriate level by an amplifier 4 and combined with the reference signal wave (frequency: fLO1) by a signal combiner 5a to generate an intermediate frequency multiplex signal wave 7 (frequency: fIFmp). When the intermediate frequency multiplex signal wave 7 (frequency: fIFmp) is made, the reference signal source 14 constructed of a phase locked oscillator (PLO), a temperature compensation type crystal oscillator (TCXO) or the like is stabilized by the temperature compensation type crystal oscillator (TCXO). The reference signal wave (frequency: fLO1) is distributed by a signal distributor 5b, so that one signal is supplied to the frequency mixer 3 and the other signal is controlled to an appropriate level by the variable attenuator 12 (or a variable amplifier) or the like and combined with the second intermediate frequency signal wave (frequency: fIF2) by the signal combiner 5a.

In this case, the signal combiner 5a has a construction in which the input signals are prevented from flowing into irrelevant ports by using a signal combiner whose input terminals of a Wilkinson-type combiner, a branch-line type combiner or the like are mutually isolated. It is to be noted that the signal combiner 5a may be constructed of a circulator. On the other hand, the signal distributor 5b has a construction in which the signals distributed into two ways have the desired power levels and are prevented from flowing into irrelevant signal ports by using a signal distributor whose output terminals of a Wilkinson-type divider, a branch-line type distributor or the like are mutually isolated.

In this first embodiment, the first intermediate frequency signal wave 108a (frequency: fIF1) is a signal of 500 MHz to 1500 MHz, the reference signal wave (frequency: fLO1) is a signal of 3400 MHz, and the second intermediate frequency signal wave (frequency: fIF2) is a signal of 3900 MHz to 4900 MHz. The intermediate frequency multiplex signal wave 7 (frequency: fIFmp) is a signal of 3400 MHz to 4900 MHz.

In this case, the following operation is carried out during the first frequency conversion (note that the symbol: a ε B indicates ones “a” that belong to a set B as the element of the set B).

(1-1) First Frequency Conversion

$$\begin{matrix}fIF2 = fLO1 + fIF1 \\ = 3400 MHz + ( 500 MHz to 1500 MHz ) \\ = 3900 MHz to 4900 MHz\end{matrix}$$

(1-2) Generation of Multiplex Wave in IF Stage fLO1, fIF2 ε fIFmp

The intermediate frequency multiplex signal wave 7 (frequency: fIFmp) is inputted to the second frequency converting section 19 and frequency-upconverted to the milliwave band by the second frequency mixer 8 that serves as the second frequency converting means and a local oscillator 11. Either the upper sideband signal or the lower sideband signal is selected by the second bandpass filter 9, and the unnecessary wave signal accompanying the second frequency conversion are suppressed. In this first embodiment, the lower sideband is suppressed, and the upper sideband is used. Then, the signal wave filtered by the second bandpass filter 9 is amplified by a transmission amplifier 10 and transmitted as a radio multiplex signal wave 115 (frequency: fRFmp) from a transmission antenna 15.

The multiplex wave generating means is constituted of the signal combiner 5a and the attenuator 12, while the transmission means is constituted of the transmission amplifier 10 and the transmission antenna 15.

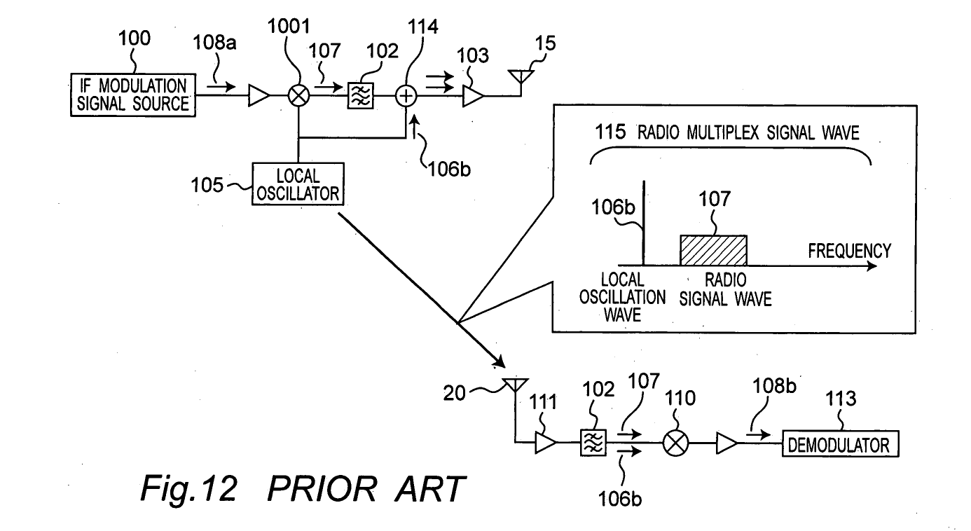

In this first embodiment, the local oscillation frequency of the local oscillator 11 is a local oscillation frequency of a half of the oscillation frequency fLO2 of the fundamental wave mixer employed in the conventional milliwave band transmitter (shown in FIG. 12) by employing an even harmonic mixer constructed of an anti-parallel diode pair for the second frequency mixer 8, and a signal of fLOH=27.8 GHz is used. In this case, the frequency fRFmp of the radio multiplex signal wave 115 becomes 59 GHz to 60.5 GHz, the frequency fp of the radio reference signal wave 106 becomes 59.0 GHz, and the frequency fRF of the radio signal wave 107 becomes 59.5 GHz to 60.5 GHz.

In this case, the following operation is carried out in the second frequency converting section 19.

(2-1) Frequency Conversion of Reference Signal Wave

$$\begin{matrix}fp = fLO1 + fLO2 \\ = fLO1 + fLOH * 2 \\ = 3.4 GHz + 27.8 GHz * 2\end{matrix}$$

(2-2) Frequency Conversion of Radio Signal

$$\begin{matrix}fRF = fIF2 + fLO2 \\ = fIF2 + fLOH * 2 \\ = ( 0.5 GHz to 1.5 GHz ) + 27.8 GHz * 2 \\ = 59.5 GHz to 60.5 GHz\end{matrix}$$

(2-3) Radio Multiplex Wave Signal fRF, fp ε fRFmp

By thus constituting the microwave band radio transmitter, it becomes extremely easy to control the output levels of the radio reference signal wave 106 (frequency: fp), the radio signal wave 107 (frequency: fRF) and the unnecessary one-side sideband signal wave. That is, in the aforementioned microwave band radio transmitter, the second intermediate frequency signal wave (frequency: fIF2=fLO1+fIF1) inputted to the second frequency converting section 19 and the first intermediate frequency reference signal wave (frequency: fLO1) have their levels controllable by the variable amplifier 2 and the variable attenuator 12 (AGC amplifier or the like) which are provided in the input stage, so that the powers of the second local oscillation frequencies fLO2 and fLOH can be made constant and fixed. With this arrangement, the output levels of the desired radio signal wave 107 (frequency: fLO1+fLO2+fIF) after the second frequency conversion and the desired radio reference signal wave 106 (frequency: fLO1+fLO2) can also be controlled.

In addition, in the second frequency converting section 19, the local oscillation wave (frequency: fLO2) itself contributes only to the second frequency conversion instead of the radio multiplex signal wave 115 (frequency: fRFmp) radiated directly from the transmitter, and therefore, it becomes possible to utilize also a harmonic mixer such as an even harmonic mixer for the second frequency mixer 8. Therefore, not only the fundamental oscillation wave fLO2=55.6 GHz but also the oscillation signals of 55.6 GHz/2=27.8 GHz and 55.6 GHz/4=13.9 GHz can be used for the local oscillation frequency. Therefore, the circuit construction and high frequency mounting become remarkably easy.

Further, by carrying out frequency conversion in the first frequency converting section 18, the interval between the frequency fLO2 of the local oscillation wave and the frequency fRF (=fLO1+fLO2+fIF1) of the radio signal wave 107 is increased to fLO1+fIF1 (=fIF2). Therefore, if the second, third, fourth, fifth, . . . components of the frequencies fLO1 and fIF2 are disadvantageously outputted due to the influence of the nonlinearity of the frequency mixer 8 on the second intermediate frequency fIF2 (=fIf1+fLO1) that is the input signal to the second frequency converting section 19 and the reference signal wave (frequency: fLO1), the frequency interval becomes widened in the milliwave band frequency-upconverted by the second frequency converting section 19, and suppression can easily be achieved by the second bandpass filter 9.

For example, assuming that fLO2=4.0 GHz, fIF2=4.5 GHz to 5.5 GHz and fLO2=55.0 GHz, then the frequency fp of the radio reference signal wave becomes 59.0 GHz and the frequency fRF of the radio signal wave becomes 59.5 GHz to 60.5 GHz through the frequency upconversion by the second frequency converting section 19. On the other hand, the second, third, . . . harmonic components of the reference signal wave (frequency: fLO1) and the second intermediate frequency signal wave (frequency: fIF2) respectively become as follows.
2*fLO1=8 GHz, 2*fIF2=9 GHz to 11 GHz,
3*fLO1=12 GHz, 3*fIF2=13.5 GHz to 16.5 GHz,

Therefore, by carrying out the frequency upconversion to the milliwave band, fLO=55 GHz is added to these frequencies, and frequency spectrum components are generated at the frequencies of 63 GHz, 64 GHz to 66 GHz, 67 GHz and 68.5 GHz to 71.5 GHz. However, because of the separation from the radio signal wave (frequency: fRF) by at least 1.5 GHz or more, those components can easily be suppressed by the second bandpass filter 9. As a result, the radio transmission bandwidth can be extended. In addition, by employing an even harmonic mixer of an anti-parallel type diode pair or the like for the second frequency mixer 8, the second harmonic components of the second intermediate frequency fIF2 and the frequency fLO1 of the reference signal wave can be suppressed and removed by the operation of frequency upconversion to the milliwave band. Therefore, in the aforementioned concrete example, there is no possibility of the output of the components of 63 GHz and 64 GHz to 66 GHz, and the radio transmission bandwidth can be extended more accurately.

If the first intermediate frequency fIF1 is set to 0.5 GHz to 1.5 GHz, then the influences of the generation of the higher harmonics due to the first frequency mixer 3 in the first frequency converting section 18 are removed. This is because the frequency mixer 3 whose input and output frequencies are low is allowed to have a double-balanced mixer construction, and therefore, the suppression of the secondary distortion is sufficient, making it possible to achieve further suppression and removal by the bandpass filter 13.

On the other hand, in the aforementioned microwave band radio receiver, the wirelessly transmitted radio multiplex signal wave 115 is received by the reception antenna 20 and amplified by the low-noise reception amplifier 21. The signal of the desired passband (59.0 GHz to 60.5 GHz in the first embodiment) is filtered by the second band-pass filter 9 and frequency-downconverted by the frequency mixer 22. In the operation of frequency downconversion, a first intermediate frequency signal wave 108b (frequency: fIF1) is generated by carried out the frequency downconversion of the radio signal wave 107 (frequency: fRF) by the radio reference signal wave 106 (frequency: fp) in the radio multiplex signal wave 115. In this first embodiment, the frequency fIF1 of the first intermediate frequency signal wave 108b is set to 500 MHz to 1500 MHz. The first intermediate frequency signal wave 108b (frequency: fIF1) is amplified to an appropriate level by an amplifier 23, and the signal waves other than those in the above-mentioned band (500 MHz to 1500 MHz) are suppressed by a bandpass filter 24. After passing through the bandpass filter 24, the signal wave is inputted to the demodulator and tuner 113.

In this case, the following operation is carried out during the frequency downconversion on the reception side.

$$\begin{matrix}fIF1 = fRF - fp \\ = ( 59.5 GHz to 60.5 GHz ) - 59.0 GHz \\ = 0.5 GHz to 1.0 GHz\end{matrix}$$

The frequency mixer 22 carries out the frequency downconversion of the radio signal wave 107 (frequency: fRF) by the radio reference signal wave 106 (frequency: fp) in the radio multiplex signal wave 115. In the above stage, although the linear detection is conducted in the region where the reception level is very large, the square-law detection is conducted in the region where the reception level is small. That is, in the frequency mixer 22, the radio reference signal wave 106 (frequency: fp) operates at a large signal level in the linear detection region, and therefore, frequency mixing is carried out depending on the input level of the radio signal wave 107 (frequency: fRF) without depending on the level of the radio reference signal wave 106 (frequency: fp). Therefore, if the level of the radio multiplex signal wave 115 at the input level is reduced by 6 dB, then the first intermediate frequency signal wave 108b (frequency: fIF1) of the output is reduced by 6 dB. On the other hand, in the region where the radio transmission distance is elongated and the reception level is reduced, the radio reference signal wave 106 (frequency: fp) and the radio signal wave 107 (frequency: fRF) operate with small signals in the frequency mixer 22, and the reductions in the levels of both the signal waves influence the output level of the intermediate frequency signal wave 108b (frequency: fIF1). Consequently, the frequency downconversion is carried out depending on the levels of both the input level of the radio signal wave 107 (frequency: fRF) and the level of the radio reference signal wave 106 (frequency: fp). Therefore, if the radio multiplex signal wave 115 is reduced by 6 dB as the input level of the frequency mixer 22, i.e., if the radio reference signal (frequency: fp) and the radio signal wave (frequency: fRF) are each reduced by 6 dB, then the first intermediate frequency signal wave 108b (frequency: fIF1) of the output is reduced by 12 dB.

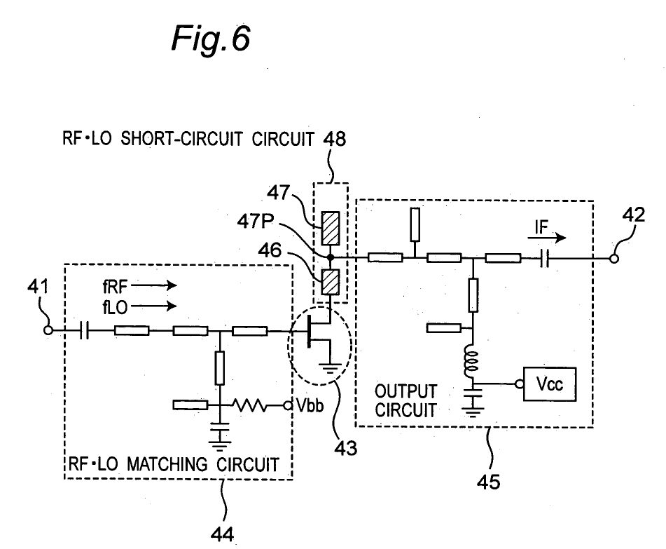

In the aforementioned first embodiment, by preferably using an active mixer including a microwave transistor for the frequency mixer 22, it becomes possible to extend the linear detection operation region. FIG. 6 shows the concrete circuit construction of the active mixer on the reception side. The operation of the active mixer employed as the frequency mixer 22 will be described with reference to FIGS. 5 and 6.

The radio multiplex signal wave 115 that has passed through the bandpass filter 9 on the reception side, i.e., the radio reference signal wave 106 (frequency: fp=fLO1+fLO2) and the radio signal wave 107 (frequency: fRF=fLO1+fLO2+fIF1) are inputted to an input port 41 and matched with the input impedance of a microwave transistor 43 by an RF∩LO matching circuit 44. In the microwave transistor 43, the radio reference signal wave 106 (frequency: fp) operates as a local oscillation wave to frequency-downconvert the radio signal wave 107 (frequency: fRF) to the first intermediate frequency signal wave 108b (frequency: fIF1). The frequency-downconverted first intermediate frequency signal wave 108b (frequency: fIF1) is outputted from an output port 42 via an RF•LO short-circuit circuit 48 on the output side of the microwave transistor 43 and an output circuit 45. The output circuit 45 is a circuit that further suppresses the RF•LO signal and converts the converted IF signal into an appropriate impedance (e.g., high impedance). In this case, the RF•LO short-circuit circuit 48 including a transmission line 46, an open stub 47 or the like is provided in the vicinity of the output terminal of the microwave transistor 43. By making both the signal waves of the radio reference signal wave 106 (frequency: fp) that serves as the outputted local oscillation wave in the milliwave band and the radio signal wave 107 (frequency: fRf) have a short-circuit impedance at a connection point 47P of the open stub 47 and the transmission line 46, adjusting them to an appropriate phase by the transmission line 46 and feeding them back to the microwave transistor 43, the internal operation of the microwave transistor 43 is shifted to larger signal operation.

The linear detection operation is achieved with respect to the smaller input level of the radio multiplex signal wave 115 by the RF•LO short-circuit circuit 48, and therefore, the frequency conversion efficiency of this frequency mixer 22 to the intermediate frequency fIF can be increased. Dissimilarly to the generally employed three-terminal type mixer that has an LO port, an RF port and an IF port, there are provided advantages that a circuit for separating the RF port from the LO port in the input port becomes unnecessary, and the performance of the microwave transistor type frequency mixer that has a low conversion loss can be sufficiently produced.

Furthermore, in the aforementioned microwave band radio receiver, the radio signal wave 107 (frequency: fRf) is frequency-downconverted by the radio reference signal wave 106 (frequency: fp) in the radio multiplex signal wave 115. Therefore, dissimilarly to the operation of the normal three-terminal mixer, the reference signal wave (operating as the local oscillation signal) level is small. Therefore, by making the microwave transistor 43 have an electrode size (gate width in an FET or emitter size in a bipolar transistor) fifty percent smaller than the size of the electrode employed in the normally employed three-terminal mixer, the internal operation of the microwave transistor 43 tends to easily shift to larger signal operation even also with respect to a smaller radio reference signal wave 106 (frequency: fp), allowing the conversion efficiency to be further increased. By reducing the frequency conversion loss on the reception side and extending the linear detection operation region with the above-mentioned construction, it becomes possible to extend the radio transmission distance.

In addition, this microwave band radio receiver can further extend the linear operation region by using a heterojunction type bipolar transistor (HBT) for the microwave transistor 43. This is because the transistor (HBT) can internally enter a large signal operation region due to the large mutual conductance possessed by the HBT in comparison with FET or the like, and it consequently becomes possible to extend the linear detection operation region.

Furthermore, in the microwave band radio transmitter, the linear operation region of the frequency mixer 22 on the reception side can be extended by transmitting the radio reference signal wave 106 (frequency: fp) in the radio multiplex signal wave 115 at a level at least 3 dB or more higher than that of the radio signal wave 107 (frequency: fRF). That is, the radio signal wave (frequency: fRF) is normally a multiple (multi-channel) modulation signal wave, and its bandwidth is wide and the total power level of the radio signal wave is large by comparison with those of the reference frequency fp. Therefore, by making the frequency mixer 22 carry out large signal operation with respect to the radio reference signal wave (frequency: fp) by making the level of the radio reference signal wave (frequency: fp) sufficiently larger than the total power of the radio signal wave (frequency: fRF), i.e., making the level larger by at least 3 dB or more, the linear detection operation region can be extended.

Furthermore, in this microwave band radio receiver, the linear detection region of the frequency mixer 22 can be extended also by controlling the gain of the reception amplifier 21 which is the variable gain amplifier according to the output signal level of the frequency-converted intermediate frequency signal wave (frequency: fIF). As shown in FIG. 5, after the intermediate frequency signal (frequency: fIF1) frequency-converted by the frequency mixer 22 on the reception side is amplified to the appropriate level by the amplifier 23, the fIF signal is distributed to constitute a negative feedback loop of a detector 87 for detecting the envelope, an amplifier 86 and a low-pass filter 85, and the gain of the reception amplifier 21 is controlled. This makes it possible to adjust the amplification degree of the reception amplifier 21 in accordance with the output level of the frequency-downconverted intermediate frequency (frequency: fIF1) and supply an input signal (115) at a constant level to the frequency mixer 22. Therefore, in the case where no automatic gain control function is provided like the detection characteristic of the frequency mixer 22 on the reception side shown in FIG. 4, the linear detection operation is carried out in the region where the transmission distance is short and the reception level is very large. In the region where the transmission distance is long and the reception level is small, the square-law detection operation is carried out. On the other hand, by virtue of the low-noise reception amplifier 21 that has an automatic gain control (AGC) function, it becomes possible to extend the linear detection region by increasing the gain of the reception amplifier 21 and increasing the level of the input to the frequency mixer 22 when the reception level is small. Furthermore, when the reception level is too large, it becomes possible to keep the input level constant by reducing the gain of the reception amplifier 21 and reducing the input level of the frequency mixer 22 and obtain a stabilized reception level by reducing the nonlinear distortion caused in the large signal regions of the frequency mixer 22 and the amplifier.

### Second Embodiment

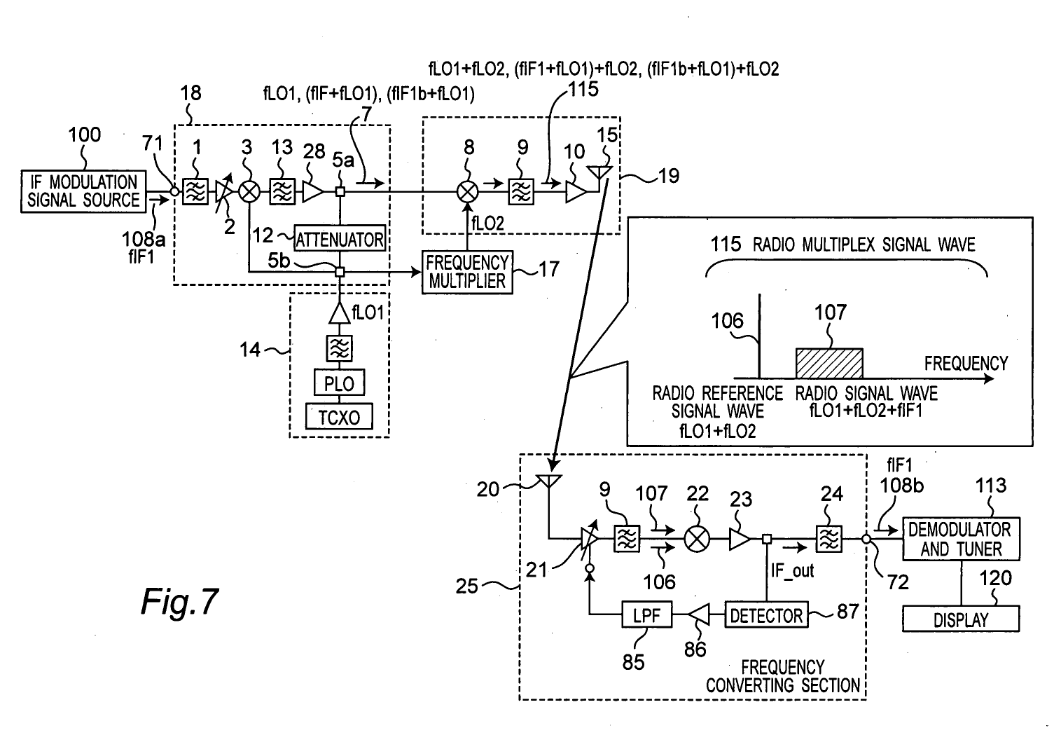

FIG. 7 is a block diagram showing the construction of a microwave band radio communication system of a second embodiment of this invention, and this microwave band radio communication system is constructed of a microwave band radio transmitter and a microwave band radio receiver. The microwave band radio communication system of this second embodiment has the same construction as that of the microwave band radio communication system of the first embodiment except for a local oscillator for the second frequency converting section 19. The same components are denoted by same reference numerals, and no description is provided therefor. The section different from the first embodiment will be described below.

Although the local oscillator 11 (shown in FIG. 5) entirely independent of the reference signal source 14 of the first frequency converting section 18 has been employed in the second frequency converting section on the transmission side in the aforementioned first embodiment, this second embodiment employs a frequency multiplier 17 as a local oscillator for the second frequency converting section 19. With this arrangement, the stable reference signal from the reference signal source 14 can be used, and this makes it possible to simply constitute a stable device without needing an independent oscillation source of a high frequency.

### Third Embodiment

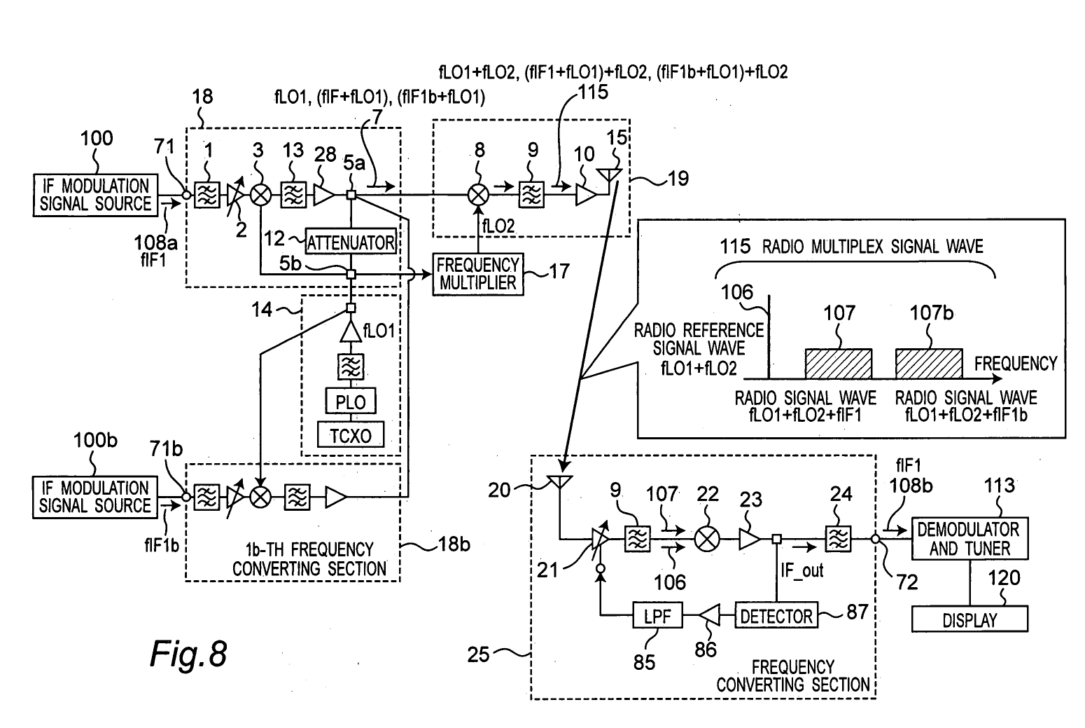

FIG. 8 is a block diagram showing the construction of a microwave band radio communication system of a third embodiment of this invention, and this microwave band radio communication system is constructed of a microwave band radio transmitter and a microwave band radio receiver. The microwave band radio communication system of this third embodiment has the same construction as that of the microwave band radio communication system of the second embodiment except for an IF modulation signal source 100b and a 1b-th frequency converting section 18b. The same components are denoted by same reference numerals, and no description is provided therefor. The sections different from the second embodiment will be described below.

As shown in FIG. 8, an IF modulation signal wave (frequency: fIF1b) is inputted from the IF modulation signal source 100b to the 1b-th frequency converting section 18b, and the signal wave is subjected to 1b-th frequency upconversion by using the local oscillation wave (frequency: fLO1) from the reference signal source 14 to generate a 2b-th intermediate frequency signal wave (frequency: fIF2b=fLO1+fIF1b). Then, the 2b-th intermediate frequency signal wave (frequency: fIF2b) is combined with the second intermediate frequency signal wave (frequency: fIF2=fLO1+fIF) that is the signal from the first frequency converting section 18 and the local oscillation wave (frequency: fLO1) from the reference signal source 14 by a signal combiner 5a and inputted as the intermediate frequency multiplex signal wave 7 to the second frequency converting section 19.

In the second frequency converting section 19, the intermediate frequency multiplex signal wave 7 (frequency: fIF1+fLO1 and fIF1b+fLO1) and the reference signal wave (frequency: fLO1) are frequency-upconverted to the milliwave band by using a second local oscillation wave (frequency: fLO2). By suppressing the unnecessary waves by the bandpass filter 9, there are generated the radio signal wave 107 (frequency: fRF=fIF1+fLO1+fLO2), a radio signal wave 107b (frequency: fRFb=fIF1b+fLO1+fLO2) and a radio reference signal wave 106 (frequency: fp=fLO1+fLO2). The radio signal waves 107 and 107b and the radio reference signal wave 106 are inputted to the transmission amplifier 10 of the milliwave band, amplified to an appropriate level and thereafter radiated as the radio multiplex signal wave 115 from the transmission antenna 15.

As described above, the frequency bandwidth of the transmission band can be extended by arranging the first frequency converting section 18 and the 1b-th frequency converting section 18b in parallel with each other, and a great amount of information of, for example, the signals of the ground wave TV broadcasting, the satellite broadcasting and so on can be multiplexed. In this case, the reference signal wave (frequency: fLO1) is one-system one-kind single frequency, which functions as a local oscillation frequency fLO1 for carrying out frequency upconversion by means of the frequency mixer 3 and a frequency mixer 3b and functions as a reference signal wave (frequency: fLO1) to be multiplexed with the second intermediate frequency signal wave (frequency: fIF2) and the 2b-th intermediate frequency signal wave (frequency: fIF2b). It is to be noted that two or more frequency converting sections may be arranged in parallel with the first frequency converting section 18.

### Fourth Embodiment

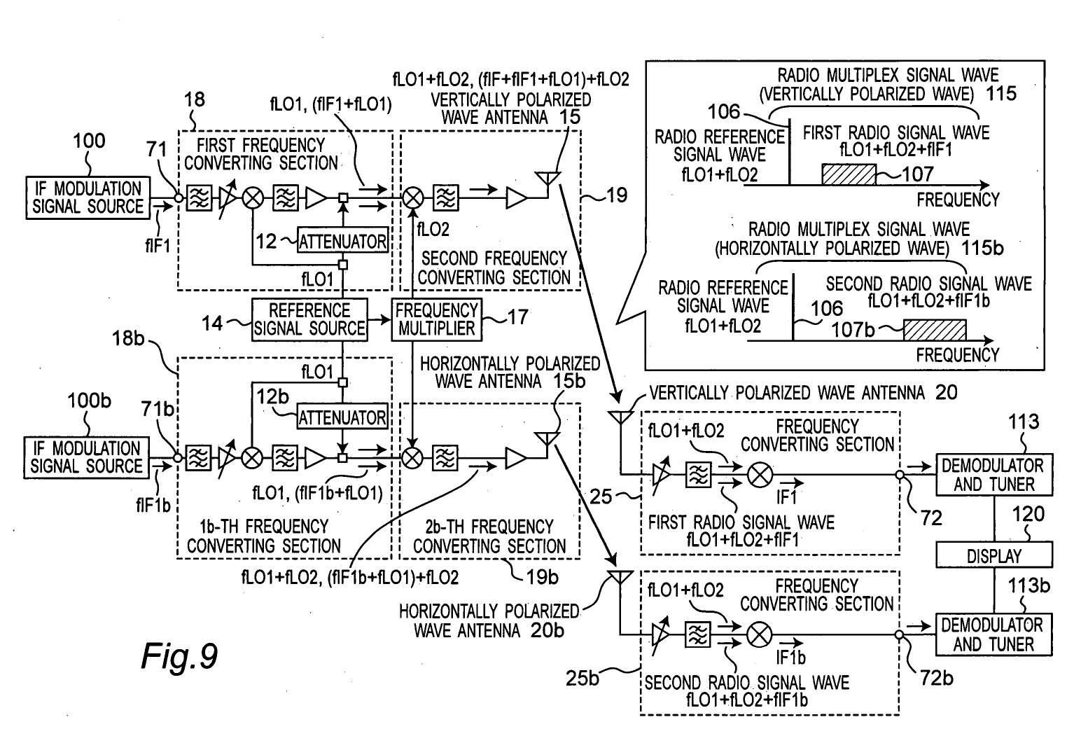

FIG. 9 is a block diagram showing the construction of a microwave band radio communication system of a fourth embodiment of this invention, and this microwave band radio communication system is constructed of a microwave band radio transmitter and a microwave band radio receiver. In the microwave band radio communication system of this fourth embodiment, the same constructions as those of the microwave band radio communication system of the second embodiment are denoted by same reference numerals, and no description is provided therefor. The section different from that of the second embodiment will be described below.

As shown in FIG. 9, another system of an IF modulation signal source 100b, a 1b-th frequency converting section 18b and a 2b-th frequency converting section 19b, which have the same constructions as those of the IF modulation signal source 100, the first frequency converting section 18 and the second frequency converting section 19, is added. The reference signal wave (frequency: fLO1) is supplied from the reference signal source 14 to both of the first frequency converting section 18 (including a reference signal multiplex section and the 1b-th frequency converting section 18b (including a reference signal multiplex section). In both the sections, the reference signal wave (frequency: fLO1) is multiplexed after the first and 1b-th frequency conversions. Further, the signal wave (frequency: fIF1+fLO) once subjected to the first frequency conversion and the reference signal wave (frequency: fLO1) are inputted to the second frequency converting section 19, while the other signal wave of fIFb+fLO that has been subjected to the 1b-th frequency conversion and the reference signal wave (frequency: fLO1) are inputted to the 2b-th frequency converting section 19. The signal waves are frequency-converted to the milliwave band by both the second frequency converting sections 19 and 19b, and a radio multiplex signal wave 115 (fLO1+fLO2 and fLO1+fLO2+fIF1) and a radio multiplex signal wave 115b (fLO1+fLO2 and fLO1+fLO2+fIF1b) are independently radiated from the independent transmission antennas 15 and 15b, respectively.

In this case, during the second and 2b-th frequency conversions, the local oscillation wave (frequency: fLO2) from the frequency multiplier 17 that serves as a local oscillator is inputted to both the second frequency converting section 19 and the 2b-th frequency converting section 19b. In this case, the reference signal source 14 (frequency: fLO1) functions as the local oscillation source of the first and 1b-th frequency converting sections 18 and 18b (including a reference signal multiplex section), while the frequency multiplier 17 (oscillation frequency: fLO2) functions as the local oscillation source of the second and 2b-th frequency converting sections. Furthermore, in this fourth embodiment, the transmission antenna 15 of vertically polarized waves is employed for the second frequency converting section 19, and the transmission antenna 15b of horizontally polarized waves is employed for the 2b-th frequency converting section 19b. However, it is acceptable to employ a right hand circular polarized wave antenna and a left hand circular polarized wave antenna.

A milliwave band transmission means is constituted of the IF modulation signal source 100, the first frequency converting section 18 and the second frequency converting section 19, while a milliwave band transmission means is constituted of the IF modulation signal source 100b, the 1b-th frequency converting section 18b and the 2b-th frequency converting section 19b of the same constructions.

In the above-mentioned microwave band radio transmitter, the level of the reference signal wave (frequency: fLO1) to be multiplexed can be subjected to independent level adjustment by the variable attenuators 12 and 12b, variable amplifiers and the like. This is because the reference signal multiplex level differs from the power level of multiplex wave generation by the reference signal wave (frequency: fLO1) due to the modulation systems and the transmission bandwidths of the IF modulation signal sources 100 and 100b.

Even in the above-mentioned microwave band radio receiver, mutually different polarized waves are received by the reception antennas 20 and 20b and frequency-converted by different frequency converting sections 25 and 25b to obtain intermediate-frequency signal waves IF1 and IF1b, which are inputted to the respective demodulators and tuners 113 and 113b.

Even the construction of the fourth embodiment produces the effects that the frequency range of the transmission band can be extended and a great amount of information can be transmitted. For example, by transmitting the ground wave TV broadcasting through frequency conversion by the system of the first frequency converting section 18 and the second frequency converting section 19 while transmitting the signal of the satellite broadcasting or the like through frequency conversion by the system of the 1b-th frequency converting section 18b and the 2b-th frequency converting section 19b, the ground wave TV broadcasting and the satellite broadcasting can be simultaneously transmitted.

Dissimilarly to the aforementioned third embodiment, the IF modulation signals (frequencies: fIF1 and fIFb), of which the reference signal level (frequency: fLO1) can be independently multiplexed, are transmitted by mutually independent transmission antennas 15 and 15b and the reception antennas 20 and 20b and independently frequency-converted with independent bandwidths by the frequency converting sections 25 and 25b that serve as the milliwave band reception means. Accordingly, there is no need to adjust the power levels of the combining circuit and signals on the transmission side, while the branching circuit can be obviated on the reception side. For example, in the case of the aforementioned TV signal, an ordinary home normally has mutually independent antenna terminals of the ground wave broadcasting and the satellite broadcasting. There are provided the advantages that the ground wave broadcasting output terminal and the satellite broadcasting output terminal can be connected to the input terminals 71 and 71b of the milliwave transmitter, and the output terminals 72 and 72b in the microwave band radio receiver on the reception side are directly connected to the tuner input terminals of the ground wave broadcasting and the satellite broadcasting, respectively, on the TV side.

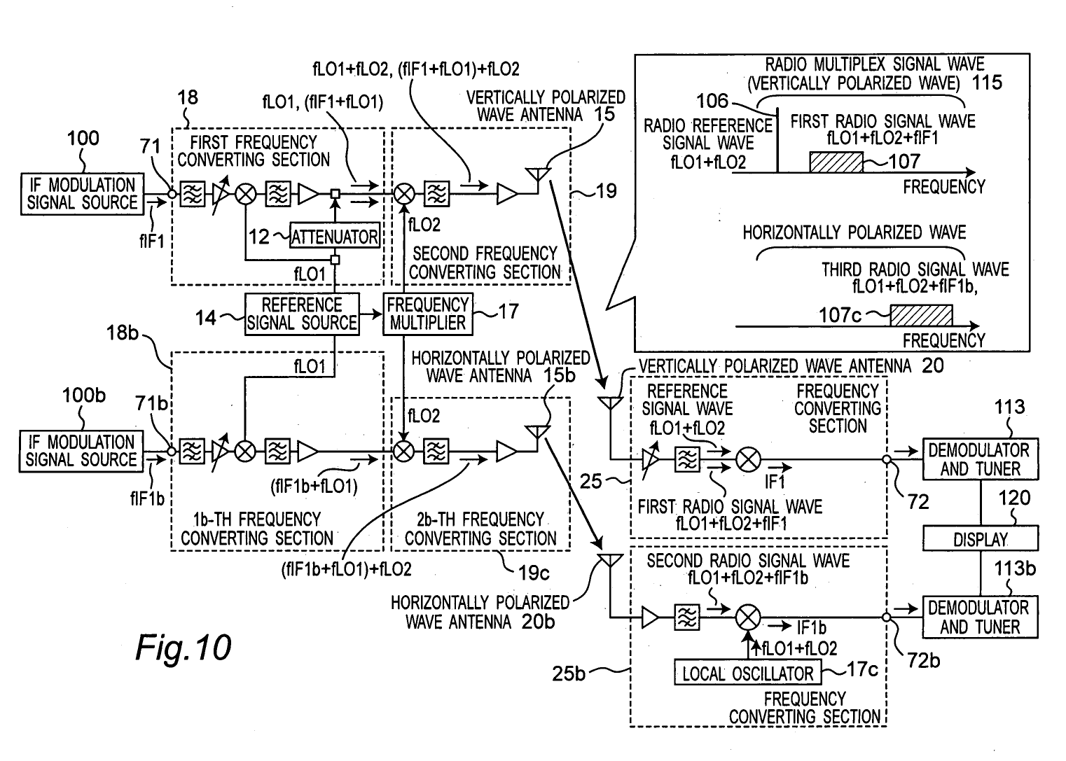

Furthermore, in this fourth embodiment, the milliwave band transmission means of both the systems have the construction in which the radio reference signal waves 106 and 106b and the radio signal waves 107 and 107b are multiplexed to constitute the radio multiplex signal waves 115 and 115b, and the radio signal waves 107 and 107b are frequency-downconverted by the transmitted radio reference signal wave (frequency: fLO1+fLO2) together with the respective frequency converting sections 25 and 25b on the reception side. However, as shown in FIG. 10, even with a microwave band radio transmitter construction in which a radio signal wave 107c (frequency: fLO1+fLO2+fIFb) is transmitted as a third radio signal without multiplexing the radio reference wave 106b in one transmission system 18b, 19c, and the radio signal is frequency-downconverted by a local oscillator 17c (frequency: fLO1+fLO2) on the reception side, there are produced the advantages that the transmission bandwidth can be extended, and the input terminals 71 and 71b and the output terminals 72 and 72b can be made independent on both the transmission side and the reception side.

### Fifth Embodiment

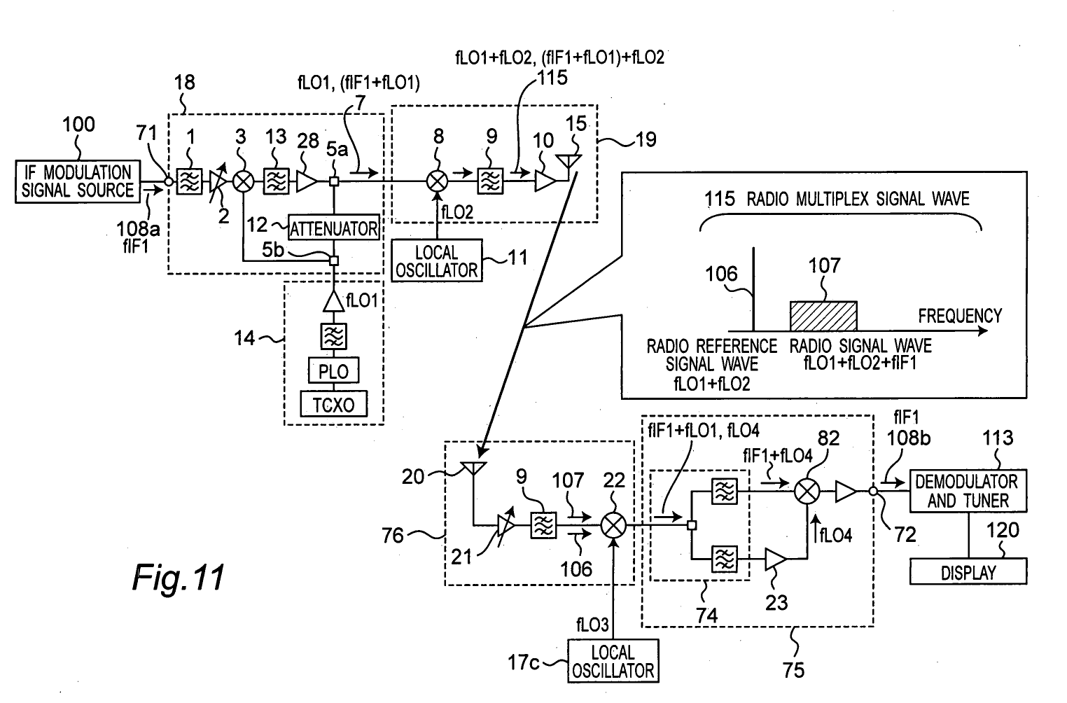

FIG. 11 is a block diagram showing the construction of a microwave band radio communication system of a fifth embodiment of this invention, and this microwave band radio communication system is constructed of a microwave band radio transmitter and a microwave band radio receiver. The microwave band radio transmitter of this fifth embodiment has the same construction as that of the microwave band radio transmitter of the first embodiment. The same components are denoted by same reference numerals, and no description is provided therefor. The section different from the first embodiment will be described below.

As shown in FIG. 11, the microwave band radio receiver on the reception side is constructed of a first frequency converting section 76 and a second frequency converting section 75. The radio multiplex signal wave 115 (frequency: fRFmp) transmitted from the transmission side is received by the reception antenna 20 and amplified by the reception amplifier 21. A second intermediate frequency multiplex signal wave (frequency: fIFmp2) is generated by passing only the radio multiplex signal wave 115 (frequency: fRFmp) of the desired wave through the bandpass filter 9 and thereafter frequency-downconverting the signal wave by the frequency mixer 22 by using an independent local oscillator 17c (frequency: fLO3) on the reception side. The second intermediate frequency multiplex signal wave (frequency: fIFmp2) frequency-converted by the first frequency converting section 76 is constituted of an intermediate frequency signal wave (frequency: fIF2) and a reference signal wave (frequency: fLO4) and has the following relations with respect to the transmission side.

(3-1) First Frequency Downconversion (fIFmp2 is Generated from fRFmp)

Generation of fIF2, fLO4 ε fIFmp2 from fRF, fp ε fRFmp
where fRF=(fLO1+fLO2)+fIF1
fp=(fLO1+fLO2)

(i) First frequency downconversion of radio signal wave 107 (Frequency: fRF)

$$\begin{matrix}fIF2 = fRF - fLO3 \\ = ( fLO1 + fLO2 + fIF1 ) - fLO3 \\ = ( fLO1 + fIF1 ) + Δ fLO\end{matrix}$$

where ΔfLO=fLO2−fLO3

(ii) First frequency downconversion of radio reference signal wave 106 (frequency: fp)

$$\begin{matrix}fLO4 = fp - fLO3 \\ = ( fLO1 + fLO2 ) - fLO3 \\ = fLO1 + Δ fLO\end{matrix}$$

After carrying out the first frequency downconversion by using the local oscillation signal fLO3 of the first frequency converting section 76 on the reception side, the second intermediate frequency multiplex signal wave (frequency: fIFmp2) is branched into an intermediate frequency signal wave (frequency: fIF2) and a reference signal wave (frequency: fLO4) by a branching filter 74 of the second frequency converting section 75. Thereafter, the first intermediate frequency signal wave (frequency: fIF1) is generated by a second frequency mixer 82. The first frequency downconversion and the second downconversion have the following relations.

(3-2) Wave Branching and Second Frequency Conversion

Generation of fIF from fIF2, fLO4 ε fIFmp2

(i) fIF2 and fLO4 are separated by wave branching

(ii) Second frequency conversion (fIF1 is generated from fIF2)

$$\begin{matrix}fIF1 = fIF2 - fLO4 \\ = ( fLO1 + fIF1 ) + Δ fLO - ( fLO1 + Δ fLO ) \\ = fIF1\end{matrix}$$

According to the above-mentioned relations, the first intermediate frequency signal wave 108b (frequency: fIF1) on the transmission side can be finally reproduced on the reception side.

In the above construction, it becomes possible to extend the radio transmission distance since the linear detection is achieved by carrying out the first frequency downconversion by means of the independent local oscillator 17c, concurrently with reducing the frequency conversion loss on the reception side.

In addition, the frequency mixer 22 on the reception side can also employ a harmonic mixer and an even harmonic mixer. Moreover, almost similar effects can be obtained by operating the frequency mixer 82 as the two-terminal mixer described in connection with the first embodiment in the intermediate frequency band without using the branching filter 74, inputting the second intermediate frequency multiplex signal wave (frequency: fIFmp2) as it is and detecting the intermediate frequency signal wave (frequency: fIF2) in the second intermediate frequency multiplex signal wave (frequency: fIFmp2) by the reference signal wave (frequency: fLO4). This is because the fIFmp2 component generated through the linear detection by the first frequency converting section 76 has a high power level and enables operation in the linear detection region. Moreover, by employing a microwave transistor for the two-terminal mixer, the gain of the microwave transistor can be positively utilized since the operation frequency is in a frequency band lower than fIFmp2 (once frequency-downconverted in the first frequency converting section 76), and higher conversion efficiency from fIF2 to fIF1 can be obtained.

In the present embodiment, it is acceptable to insert an amplifier between the first frequency converting section 76 and the second frequency converting section 75 in order to adjust the input level to the second frequency converting section 75 to an appropriate level (operation region of linear detection) at need.

1. A microwave band radio transmitter comprising:
a multiplex wave generating means generating an intermediate frequency multiplex signal wave by adding a reference signal wave whose level is controlled by a level control means to an input modulation signal wave or an intermediate frequency signal wave;
a second frequency converting means frequency-upconverting the intermediate frequency multiplex signal wave generated by the multiplex wave generating means to a microwave; and
transmission means amplifying a multiplex signal wave of a microwave band frequency-upconverted by the second frequency converting means and transmitting the amplified multiplex signal wave as a radio multiplex signal wave comprised of a radio reference signal wave and a radio signal wave.

2. The microwave band radio transmitter as claimed in claim 1, wherein
the reference signal wave is a sine wave.

3. The microwave band radio transmitter as claimed in claim 1, comprising:
a first frequency converting means frequency-upconverting the input modulation signal wave to an intermediate frequency signal wave.

4. The microwave band radio transmitter as claimed in claim 3, wherein
the reference signal wave is a local oscillation wave used for the first frequency converting means.

5. The microwave band radio transmitter as claimed in claim 1, further comprising a local oscillator for supplying a local oscillation wave to the second frequency converting means, wherein
the local oscillator is comprised of a frequency multiplier whose input frequency is a frequency of the reference signal wave.

6. The microwave band radio transmitter as claimed in claim 1, wherein
the second frequency converting means is a harmonic mixer.

7. The microwave band radio transmitter as claimed in claim 1, wherein
the second frequency converting means is an even harmonic mixer.

8. The microwave band radio transmitter as claimed in claim 1, comprising two systems of microwave band transmission means having the multiplex wave generating means, the second frequency converting means and the transmission means, wherein
a first input modulation signal is inputted to one of the microwave band transmission means,
a second input modulation signal is inputted to the other of the microwave band transmission means, and
a first radio multiplex signal wave and a second radio multiplex signal wave, both of which are generated by the respective microwave band transmission means, are transmitted in the forms of different polarized waves.

9. The microwave band radio transmitter as claimed in claim 1, wherein
the radio reference signal wave in the radio multiplex wave signal is transmitted at a power level higher than that of the radio signal wave.

10. A microwave band radio receiver comprising a frequency converting means frequency-downconverting a radio multiplex signal wave transmitted from a transmission side by a radio reference signal wave contained in the radio multiplex signal wave.

11. The microwave band radio receiver as claimed in claim 10, comprising a variable gain amplifier for reception amplifying the radio multiplex signal wave, wherein
an intermediate frequency signal wave is generated by frequency-downconverting the radio multiplex signal wave amplified by the variable gain amplifier for reception by the frequency converting means, and a gain of the variable gain amplifier for reception is controlled by an output signal level of the intermediate frequency signal wave.

12. The microwave band radio receiver as claimed in claim 10, wherein
the frequency converting means is a frequency mixer that employs a microwave transistor.

13. The microwave band radio receiver as claimed in claim 12, wherein
the frequency mixer is a frequency downconverter, which has an input terminal and an output terminal and has a short-circuit circuit to be short-circuited at a frequency of the radio multiplex signal wave or an intermediate frequency multiplex signal wave and connected to an output part of the microwave transistor to which the radio multiplex signal wave or the intermediate frequency multiplex signal wave is inputted.

14. The microwave band radio receiver as claimed in claim 13, wherein
the microwave transistor of the frequency mixer is a heterojunction type bipolar transistor.

15. The microwave band radio receiver as claimed in claim 10, comprising two systems of microwave band radio receivers that have the frequency converting means, wherein
an intermediate frequency signal is generated by frequency-downconverting two radio multiplex signal waves transmitted in the forms of different polarized waves from a transmission side by the two microwave band receiving means, respectively.

16. A microwave band radio receiver comprising:
a first frequency converting means frequency-downconverting a radio multiplex signal wave transmitted from a transmission side to an intermediate frequency multiplex signal wave by means of a local oscillator on a reception side; and
a second frequency converting means generating an intermediate frequency signal wave by frequency-downconverting by means of a reference signal wave contained in the intermediate frequency multiplex signal wave the intermediate frequency multiplex signal wave that has been frequency-downconverted by the first frequency converting means.

17. The microwave band radio receiver as claimed in claim 16, wherein
the second frequency converting means is a frequency mixer that has an input terminal and an output terminal and has a microwave transistor.

18. A microwave band radio communication system comprising the microwave band radio transmitter claimed in claim 1 and a microwave band radio receiver comprising a frequency converting means frequency-downconverting a radio multiplex signal wave transmitted from a transmission side by a radio reference signal wave contained in the radio multiplex signal wave.

19. A microwave band radio communication system comprising the microwave band radio transmitter claimed in claim 1 and a microwave band radio receiver a first frequency converting means frequency-downconverting a radio multiplex signal wave transmitted from a transmission side to an intermediate frequency multiplex signal wave by means of a local oscillator on a reception side; and
a second frequency converting means generating an intermediate frequency signal wave by frequency-downconverting by means of a reference signal wave contained in the intermediate frequency multiplex signal wave the intermediate frequency multiplex signal wave that has been frequency-downconverted by the first frequency converting means.

20. The microwave band radio communication system as claimed in claim 18, wherein
the input modulation signal wave of the microwave band radio transmitter is a signal wave comprised of either one or a combination of two or more of a ground wave TV broadcasting wave signal, a satellite broadcasting intermediate frequency signal wave and a cable TV signal wave.

21. The microwave band radio communication system as claimed in claim 19, wherein
the input modulation signal wave of the microwave band radio transmitter is a signal wave comprised of either one or a combination of two or more of a ground wave TV broadcasting wave signal, a satellite broadcasting intermediate frequency signal wave and a cable TV signal wave.
